(19) United States
(12) Patent Application Publication
(10) Pub. No.: US 2014/0084728 A1
(43) Pub. Date: Mar. 27, 2014

(54) ROTATING ELECTRICAL MACHINE AND ELECTRIC POWER STEERING SYSTEM USING THE SAME

(71) Applicant: Hitachi Automotive Systems, Ltd., Hitachinaka-shi (JP)

(72) Inventors: Norihisa IWASAKI, Tokyo (JP); Masashi KITAMURA, Tokyo (JP); Hiroshi KANAZAWA, Tokyo (JP); Shozo KAWASAKI, Hitachinaka (JP)

(73) Assignee: Hitachi Automotive Systems, Ltd., Hitachinaka-shi (JP)

(21) Appl. No.: 13/973,233

(22) Filed: Aug. 22, 2013

(30) Foreign Application Priority Data
Sep. 27, 2012 (JP) 2012-213393

(51) Int. Cl. H02K 3/00

(52) U.S. Cl. CPC H02K 3/00
USPC 310/156.01

(57) ABSTRACT

A concentrated winding motor having the combination of the number of poles and the number of slots of 10:12 or 14:12 includes coils in the same phase that are adjacent to each other and have mutually different numbers of coil turns.

### BACKGROUND OF THE INVENTION

1. Field of the Invention

The present invention relates to a rotating electrical machine and an electric power steering system using the same.

2. Description of the Related Art

In response to the recent trend of replacing a hydraulic system by an electric system as well as introducing a hybrid electric vehicle (HEV) and an electric vehicle (EV) on the market, there has been a rapid increase in the percentage of vehicles equipped with an electric power steering (EPS). An auxiliary machine onboard a vehicle that is typified by an electric power steering motor uses an in-vehicle battery (such as a 12-V battery) as the source of energy and is driven under a low-voltage condition. However, an EPS motor for which a high rotational speed-torque characteristic (an N-T characteristic) is required cannot support up to a high rotational speed region unless the number of coil turns is decreased. Being required to generate large torque, moreover, the motor needs to be powered by a large current, thereby requiring the wire diameter of a coil to be increased. The coil with a large wire diameter however exhibits high rigidity in a magnet wire, which makes it difficult for the coil to increase a space factor thereof within a stator slot of the motor. Accordingly, there has been adopted a highly accurate, regular concentrated winding pattern using a split core. As a technology to improve the space factor, for example, JP-2001-197696-A discloses a method in which the coil is wound in a double-stack arrangement within a slot and connected in parallel by a thin wire so as to equivalently increase the wire diameter. In addition, JP-2011-4456-A discloses a method in which the space factor is improved by devising the shape of a stator core and adopting a distributed winding pattern.

### SUMMARY OF THE INVENTION

The EPS motor directly conveys, to a human's hand, torque ripple/friction of the motor provided between the hand and tires through a steering wheel. Accordingly, there is a stringent requirement for the EPS motor pertaining to cogging torque and the torque ripple. The combination of the number of poles and the number of slots becomes highly important in the abatement of the cogging torque and the torque ripple generated in the motor. When a motor with 12 slots employing a concentrated winding pattern is provided, for example, the number of poles that can be selected is 8, 10, 14, and the like. Here, superior characteristic can be obtained regarding the abatement of the cogging torque and the torque ripple when 10 or 14 poles are selected. The maximum number of parallel circuits on a stator side is two when 10 or 14 poles are selected. When 8 poles are selected, on the other hand, the possible maximum number of parallel circuits is increased to four. Although favorable regarding the abatement of the cogging torque and the torque ripple, the motor with 10 or 14 poles has the maximum number of parallel circuits smaller than the motor with 8 poles, whereby the wire diameter of the coil need be further increased, which can cause the decrease in the space factor.

An object of the present invention is to provide a high-space factor, high-torque rotating electrical machine while alleviating the cogging torque and the torque ripple.

In order to provide a rotating electrical machine that is excellent in both alleviating the torque ripple and achieving high torque in the present invention, the ratio of the number of poles to the number of slots is set to an integral multiple of 10:12 or an integral multiple of 14:12, while the number of turns of adjacent coils in the same phase in a stator is set to mutually different numbers.

According to the present invention, a high-space factor, high-torque design can be realized while alleviating the cogging torque and the torque ripple and, accordingly, a rotating electrical machine suitable for an electric power steering can be provided.

### BRIEF DESCRIPTION OF THE DRAWINGS

FIG. 1 is a diagram illustrating an electric power steering system according to an embodiment of the present invention;

FIG. 2A is a diagram illustrating an electric power steering system according to an embodiment of the present invention;

FIG. 2B is a diagram illustrating an electric power steering system according to an embodiment of the present invention;

FIG. 3A is a diagram illustrating an electric power steering system according to an embodiment of the present invention;

FIG. 3B is a diagram illustrating an electric power steering system according to an embodiment of the present invention;

FIG. 4 is a diagram illustrating an electric power steering motor and a control unit according to an embodiment of the present invention;

FIG. 5A is a diagram illustrating a construction of an electric power steering motor according to an embodiment of the present invention;

FIG. 5B is a diagram illustrating a construction of a rotor in an electric power steering motor according to an embodiment of the present invention;

FIG. 5C is a diagram illustrating the assembling of a split stator core and a bobbin in an electric power steering motor according to an embodiment of the present invention;

FIGS. 6A to 6C are diagrams illustrating a stator in an electric power steering motor according to an embodiment of the present invention, where FIG. 6A is a diagram illustrating the winding arrangement of the stator, FIG. 6B is a diagram illustrating the assembly of a stator core, and FIG. 6C is a detail view in which a stator coil is wound around a stator bobbin;

FIGS. 7A and 7B are diagrams illustrating a stator in an electric power steering motor according to an embodiment of the present invention, where FIG. 7A is a diagram illustrating the assembly of a stator core, and FIG. 7B is a detail view in which a stator coil is wound around a stator bobbin;

FIGS. 8A and 8B are diagrams illustrating a stator in an electric power steering motor according to an embodiment of the present invention, where FIG. 8A is a diagram illustrating the assembly of a stator core, and FIG. 8B is a detail view in which a stator coil is wound around a stator bobbin;

FIGS. 9A and 9B are diagrams illustrating a stator in an electric power steering motor according to an embodiment of the present invention, where FIG. 9A is a diagram illustrating the assembly of a stator core, and FIG. 9B is a detail view in which a stator coil is wound around a stator bobbin;

FIGS. 10A to 10C are a set of characteristic graphs illustrating the effects of the present invention;

FIGS. 11A to 11D are a set of detail views of a stator core provided in an electric power steering motor according to an embodiment of the present invention;

FIGS. 12A to 12E are a set of detail views of a rotor core and a rotor magnet that are provided in an electric power steering motor according to an embodiment of the present invention; and

FIGS. 13A to 13D are a set of detail views of a rotor core and a rotor magnet that are provided in an electric power steering motor according to an embodiment of the present invention.

### DESCRIPTION OF THE PREFERRED EMBODIMENTS

A rotating electrical machine according to the present invention will be described below with reference to the drawings. Note that the description of the rotating electrical machine as an electric power steering motor in the present embodiment can also be applied to a general auxiliary machine onboard a vehicle including a brushless motor.

### First Embodiment

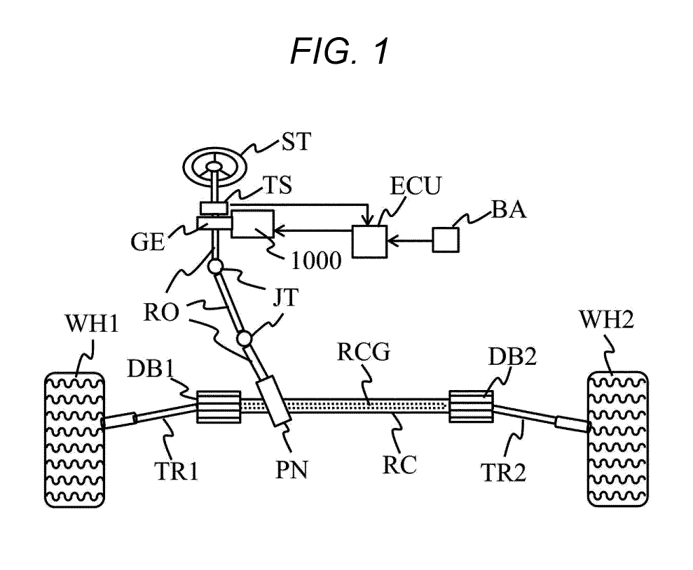

A first embodiment of the present invention will now be described. The operating principle of an electric power steering system according to the present embodiment will be described first with reference to FIGS. 1 to 3. An electric power steering system according to the present embodiment includes: an in-vehicle battery; a control unit which converts DC power supplied from the in-vehicle battery via a wire harness into polyphase AC power and controls the output thereof in accordance with torque applied onto a steering; and an electric power steering motor which is driven by the AC power supplied from the control unit in order to output torque to assist the steering. The electric power steering motor includes a frame, a stator fixed to the frame, and a rotor disposed in opposed relation to the stator by way of an air gap, the stator including a stator core and a polyphase stator coil incorporated into the stator core. The stator core includes an annular back core portion and a plurality of tooth core portions which is projected into a radial direction from the back core portion. A slot is formed between the adjacent tooth core portions of the stator core, where the stator coil is stored in the slot. The rotor includes a rotor core and a plurality of magnets which is either fixed to the outer peripheral surface of the rotor core or embedded thereinto.

FIG. 1 is a block diagram illustrating the electric power steering system using the electric power steering motor according to the present embodiment. The system includes: a steering wheel ST; a torque sensor TS which detects rotary drive force of the steering wheel ST; a control unit ECU which controls assist torque on the basis of the output from the torque sensor TS; a motor 1000 which outputs the assist torque on the basis of a signal from the control unit ECU controlling the assist torque; an in-vehicle battery BA which serves as the source of energy supplied to the control unit ECU and the motor 1000; a gear mechanism GE which decelerates the rotary drive force of the motor 1000 by a gear to output a desired torque; a pinion gear PN which conveys the torque generated by the gear mechanism GE; one or a plurality of rods RO which connects the pinion gear PN and the gear mechanism GE; one or a plurality of joints JT which connects the rod that connects the pinion gear and the gear mechanism; a rack gear RCG which transforms the rotary drive force generated in the pinion gear PN into horizontal force; a rack case RC which covers the rack gear RCG; a first dust boot DB1 and a second dust boot DB2 which are provided on both sides of the rack case RC to prevent dust or the like from entering the rack case RC; a first tire WH1 and a second tire WH2 which actually steer the vehicle; a first tie rod TR1 which conveys the horizontal force generated in the rack shaft to the first tire WH1; and a second tie rod TR2 which likewise conveys the horizontal force generated in the rack shaft to the second tire WH2.

FIG. 1 is a diagram illustrating a column assist-type electric power steering system where the motor 1000 for generating the assist torque is provided in the vicinity of a steering column. In the system illustrated in FIG. 1, the rotary drive force generated by rotating the steering wheel ST is detected by the torque sensor TS. The control unit ECU then calculates an energizing pattern that generates a desired assist torque on the basis of a signal detected by the torque sensor TS, and outputs a command to the motor 1000. On the basis of the command from the control unit ECU, the motor 1000 is energized to generate the assist torque, which is then decelerated by the gear mechanism GE connected to the motor 1000 so that the rotary drive force is conveyed to the pinion gear PN via the rod RO and the joint JT. The pinion gear PN is in mesh with the rack gear RCG, whereby the rotary drive force of the pinion gear PN is transformed into the thrust force directed perpendicularly to the direction of travel of a vehicle. The horizontal thrust force then steers the tires WH1 and WH2 through the tie rods TR1 and TR2. This system can be used in the condition where the surrounding temperature is relatively low because the motor is arranged in the vehicle interior away from an engine room. As a result, the system can be designed with a relatively lenient condition regarding yield strength against demagnetization when the system includes a permanent magnet motor using a neodymium sintered magnet that may possibly be demagnetized at a high temperature. Disposed close to a driver, however, the system need be designed under a stringent condition regarding vibration and noise of the motor. While the control unit ECU and the motor 1000 are illustrated separately in FIG. 1, the control unit ECU may also be connected to the motor 1000 on the side opposite from the output shaft thereof to integrally serve as a mechatronic unit.

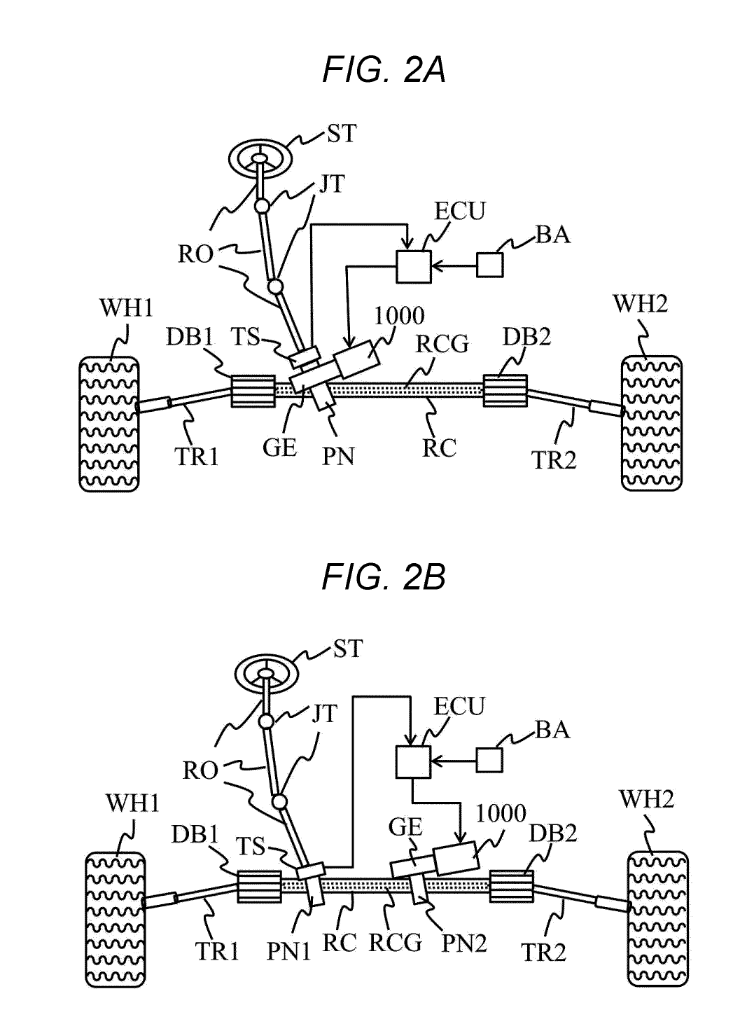

FIGS. 2A and 2B are diagrams illustrating a pinion assist-type electric power steering system where the motor 1000 for generating the assist torque is provided in the vicinity of the pinion gear PN. In the system illustrated in FIG. 2A, the motor 1000 for generating the assist torque is provided to the shaft of the pinion gear PN, but the basic operating principle of the system is no different from that of the column assist-type electric power steering system illustrated in FIG. 1. Moreover, FIG. 2B illustrates the system where, in addition to a first pinion gear PN1 connected to the steering wheel ST through the rod RO, a second pinion gear PN2 is provided in a direction opposite to the center of the rack shaft, the second pinion gear PN2 being provided with the motor 1000 that generates the assist torque. Being provided with two pinion gears, the system is referred to as a dual pinion assist-type electric power steering or a double pinion assist-type electric power steering. The motor in this system can be increased in size to achieve high power due to the fact that both the steering force by a human and the assist torque are applied to the rack gear RCG, and that a space for disposing the motor 1000 can be secured due to the pinion gear additionally being provided. Moreover, the system can be designed with a relatively lenient condition regarding vibration and sound because the motor 1000 and the driver are a long distance away from each other. Being disposed in the engine room where the surrounding temperature is relatively high, on the other hand, the system need be designed with a relatively stringent condition regarding the yield strength against demagnetization when the system employs the permanent magnet motor using the neodymium sintered magnet that may possibly be demagnetized at a high temperature.

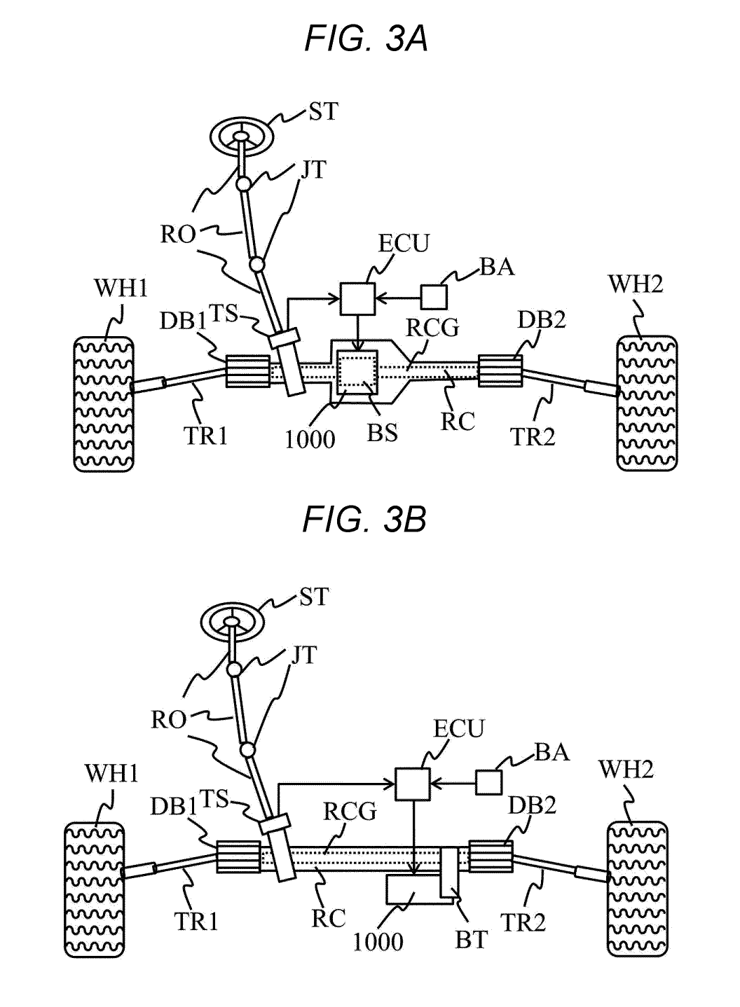

FIGS. 3A and 3B are diagrams illustrating a rack assist-type electric power steering system where the motor 1000 that generates the assist torque is provided coaxially with the rack gear RCG. In the system illustrated in FIG. 3A, the motor 1000 for generating the assist torque is built into the rack case RC. The motor 1000 having adopted a hollow shaft structure includes therein a ball screw BS formed by cutting a screw. The rotary drive force of the motor 1000 is converted into the horizontal thrust force of the rack gear RCG when the ball screw BS meshes with the rack gear RCG. In the system illustrated in FIG. 3B, the motor 1000 for generating the assist torque is provided in parallel with the rack gear RCG. In this case, the rotor shaft of the motor 1000 and the rack gear RCG are connected by a belt BT, so that the rotary drive force of the motor 1000 is converted into the horizontal thrust force of the rack gear RCG when the rack gear RCG meshes with the belt BT into which a screw-like groove is incised. The system can be designed with a relatively lenient condition regarding vibration and sound because the motor 1000 and a driver are a long distance away from each other as is the case with the pinion assist-type electric power steering that is illustrated in FIGS. 2A and 2B. Being disposed in the engine room where the surrounding temperature is relatively high, on the other hand, the system need be designed with a relatively stringent condition regarding the yield strength against demagnetization when the system employs the permanent magnet motor using the neodymium sintered magnet that may possibly be demagnetized at high temperature. In addition, the structure in this system allows for the rational and effective use of the space and is thus favorable for achieving even higher power by increasing the motor in size, for example.

The energy balance among the motor 1000, the control unit ECU, and the battery BA will now be described. When a 12 V, 100 A battery BA is used to power the motor 1000, for example, the output of the battery is approximately 1200 W. The battery BA and the control unit ECU are connected by the wire harness, the power consumed by which is approximately 200 W with the large current flowing through it even when the low resistance is achieved by using the wire harness with a large diameter (a wire harness with a conductor cross-sectional area of around 8 mm² is the maximum limit considering the easiness of routing). The power consumed by the control unit ECU is around 200 to 300 W even when the internal resistance of the control unit ECU itself is decreased. This means that about half the power that can be output from the battery BA (approximately 1200 W) is consumed by the wire harness and the control unit ECU, thereby reducing the power that can be consumed by the motor 1000 by half. A counter-electromotive force of the motor 1000 is proportional to the rotational speed and the number of coil turns, meaning that the counter-electromotive force generated by the motor is too large with respect to the input voltage when the motor runs in a high rotational speed region, which would not hold as a system. Accordingly, the system need be designed such that it supports up to the high speed region by decreasing the number of coil turns.

The EPS motor is employed in a vehicle with small displacement (small gross weight), whereas a hydraulic power steering system is currently put into practical use in a vehicle with large displacement (large gross weight). It has been practically impossible to employ a permanent magnet brushless motor in the vehicle with large displacement or large gross weight (the displacement of 1.8 L or more or the gross weight of 1.5 t or heavier, for example). This is because the vehicle with large displacement (large gross weight) cannot perform static steering owing to the large vehicle weight which causes great amount of friction between the tires and the ground. The permanent magnet-type concentrated winding brushless motor cannot achieve large torque when running at low speed due to large copper loss in the motor, thereby preventing the sufficient amount of motor current from flowing into the motor according to the aforementioned energy balance. Therefore, the EPS needs to employ a motor with small copper loss in the first place. There is a merit in sufficiently reducing the copper loss such that the heat of the motor is not conveyed to the side of the ECU of the mechatronic unit where the motor and the ECU are designed integrally.

The EPS motor requires downsizing due to the limited space on board regardless of whether it is disposed in the vicinity of the steering column or the rack and pinion as illustrated in FIGS. 1 to 3. The stator winding needs to be fixed in the motor that is downsized, where it is also important that the winding work is simple. In addition, it is desired that the torque variation such as cogging torque be suppressed to the very low level in the EPS motor, which however is required to generate large torque in order to supplement the assisting force required for the static steering. For example, the motor is required to generate large torque when a driver quickly turns the steering wheel while a vehicle is in a halt state or in a running state near halt because the frictional resistance is generated between the wheels being steered and the ground. A large current is supplied to the stator coil at this time, the current being 50 amperes or greater depending on the condition, possibly 70 or 150 amperes in some cases. The EPS mounted in a vehicle also receives vibration of various kinds as well as shock from a wheel. Moreover, the EPS motor is used under a state where there is a large change in temperature. That is, the motor may be subjected to the temperature of minus 40 degree Celsius, or 100 degree Celsius or higher due to the rise in temperature caused by the heat generated in the motor or a peripheral device. Furthermore, the motor requires means to prevent water from flowing into it. In order for the stator to be fixed to a housing case 100 under these conditions, it is desired that a stator core 200 be press-fitted into the housing case 100. After press-fitting, the stator may be further screwed from the outer periphery of the frame. It is also desired that locking be performed in addition to press-fitting.

The EPS motor is driven by a power source installed in a vehicle, the power source often having a low output voltage. A series circuit is equivalently formed of a switching element constituting an inverter across a power supply terminal, the motor, and another current supply circuit connecting means. In this circuit, the sum of a terminal voltage of each circuit component is the voltage across terminals of the power source, whereby the terminal voltage of the motor to supply a current thereto is decreased. In order to secure the current flowing into the motor under such condition, it is especially important to keep the copper loss of the motor to a low level. From this point of view, the power source installed in a vehicle often has a low voltage specification of 50 volts or less, and it is desired that a stator coil 400 be wound in the concentrated winding pattern, which is especially important when using a 12-volt power source.

As described above, it is often the case that the performance of the motor having a large number of poles cannot be obtained sufficiently in a high rotational speed region when the 12-volt power source is used. Therefore, the number of poles of the motor is preferably between 6 and 14. The concentrated winding motor with 12 slots will be described here as an example, the motor with 12 slots providing many options for the number of poles for the same number of slots within the range of the number of poles between 6 and 14. When an 8-pole, 12-slot motor is used, for example, the maximum number of parallel circuits of the stator coil is four. This 8-pole, 12-slot motor however generates large cogging torque and torque ripple, whereby the rotor magnet needs to be skewed or the like in order to satisfy the performance as the EPS motor. When a 10-pole, 12-slot motor is used, on the other hand, the cogging torque and the torque ripple can be kept smaller than the motor having another combination of the number of poles and the number of slots. The 10-pole, 12-slot motor however has the stator coil with the maximum number of parallel circuits of two. The EPS motor that is driven by a low voltage and required to generate large torque needs to increase the wire diameter of the stator coil, considering that the number of coil turns is small and that a large current flows through the coil. Therefore, the wire diameter of the stator coil in the 10-pole, 12-slot motor having two parallel circuits needs to be increased unlike the 8-pole, 12-slot motor in which four parallel circuits can be applied. With the wire diameter being increased, it is difficult to increase the space factor of the coil that is highly rigid within a motor slot. It is very important, for the motor in which the stator coil has the small number of turns like the EPS motor, to increase the space factor by increasing the coil turns by even one turn or using the coil with a large diameter.

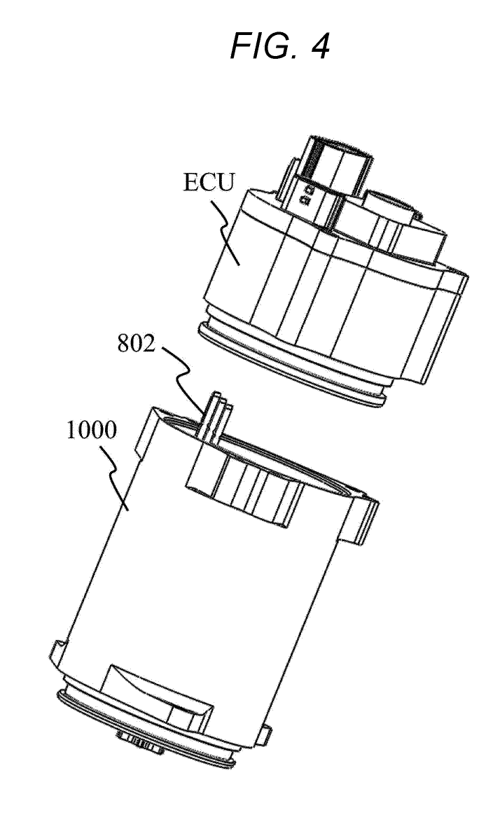

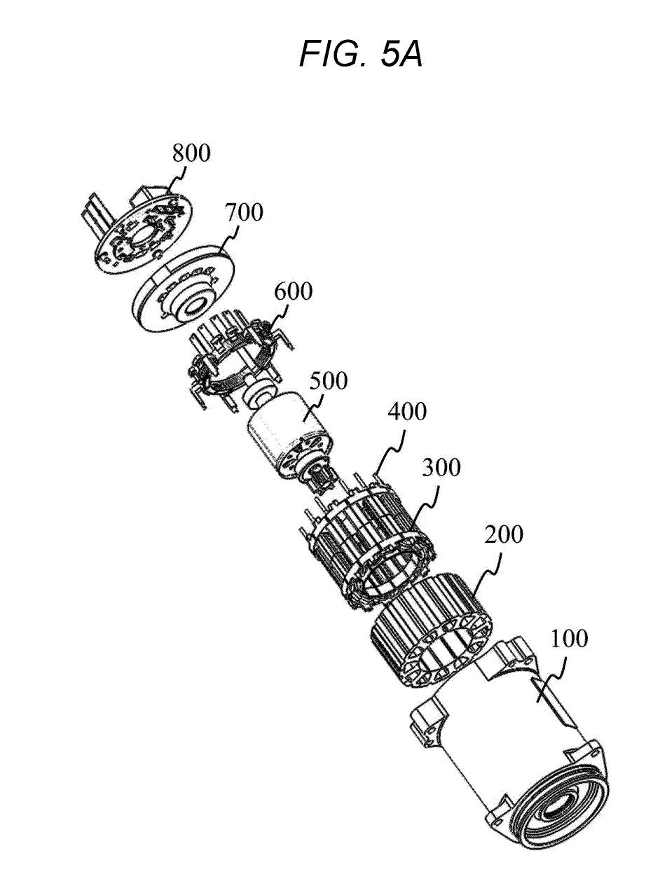

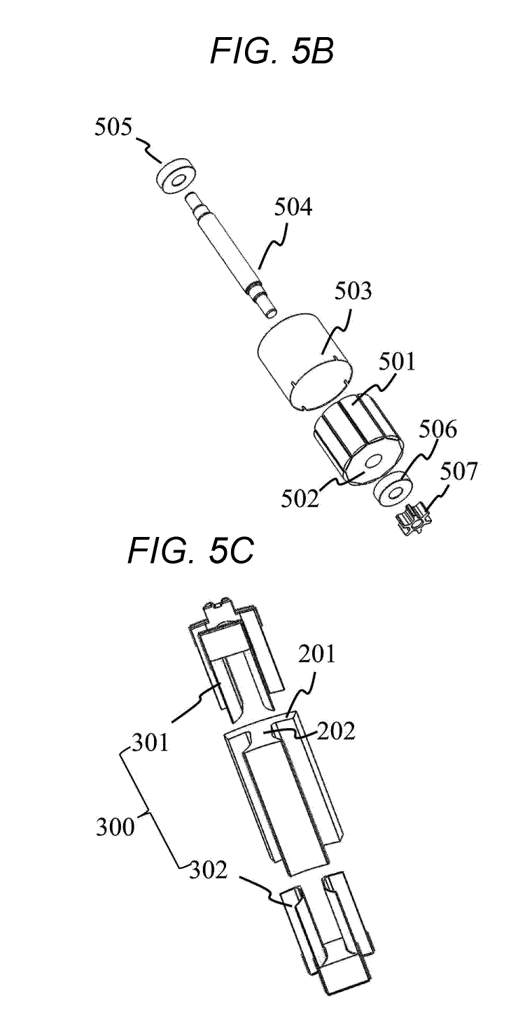

The detail structure of the motor according to the first embodiment of the present invention will now be described with reference to FIGS. 4 and 5. A specific structure of the EPS motor 1000 will be described. When a human steers a tire by way of a steering wheel, the EPS motor according to the present embodiment is energized on the basis of a signal from the control unit ECU controlling the assist torque and outputs the assist torque. The arrangement of the control unit ECU and the motor 1000 will now be described. As illustrated in FIGS. 1 to 3, the control unit ECU can be either arranged separately from the motor 1000 and connected thereto through the wire harness or the like, or can be connected directly to the motor 1000 on the opposite side of the output thereof to integrally form the mechatronic unit so as to avoid a voltage drop by the wire harness. When the mechatronic unit is employed as illustrated in FIG. 4, for example, the control unit ECU is directly connected to the motor 1000 on the side opposite to the output shaft thereof. A lead of the winding in the motor 1000 is brought into contact with and fixed to a metal portion of a bus bar 600 so that the motor is wired by a Y connection or a A connection method through the bus bar 600. The wiring bound through the bus bar is then connected to the control unit ECU by an input line 802 that is projected to the control unit ECU side.

The overall structure of the motor 1000 will now be described with reference to FIG. 5A. The motor 1000 includes: the stator core 200 which is formed of a magnetic material and fixed to the housing case 100 made of iron or aluminum; a conductive stator coil 400 wound around the stator core 200; a bobbin 300 which is formed of a non-conductive member to insulate the stator core 200 from the stator coil 400; a rotor 500 which is rotatably supported on the inner diameter side of the stator 200; the bus bar 600 which forms the input line for the motor by putting the lead of the stator coil 400 together or forms a neutral point where the Y connection method is employed; a bracket 700 which is provided on the input side of the motor 1000; and a base 800 on which the input line 802, a relay switch 801 and the like are placed together.

The aforementioned components are fabricated by the following method including: a first process of incorporating the stator coil into the stator core 200; a second process of press-fitting, into the housing case 100, a plurality of circumferential portions of the stator core 200 into which the stator coil 400 has been incorporated and obtaining a structure in which the stator core 200 into which the stator coil 400 has been incorporated is fixed to the housing case 100; and a third process of attaching the bracket 700 or a jig to the structure such that the stator core 200 and the coil end portion of the stator coil 400 projected from the axial end of the stator core 200 toward the axial direction are enclosed with the bracket 700 or the jig and the housing case 100. This method may also be adapted to be a method of manufacturing a structure molded by a mold material by performing, after the third process: a fourth process of injecting the mold material fluid into the space enclosed with the bracket 700 or the jig and the housing case 100 so that the mold material fills up the coil end portion, a gap in the stator core 200, a gap in the stator coil 400, a gap between the stator core 200 and the stator coil 400, and a gap between the stator core 200 and the housing case 100; a fifth process of solidifying the mold material; and a sixth process of removing the jig.

The structure of the rotor 500 will now be described with reference to FIG. 5B. The rotor 500 includes: a rotor core 502 which fixes a permanent magnet in position; at least two permanent magnets 501 disposed in the circumferential direction on the outer peripheral surface of the rotor core 502; a cover 503 which is provided for the permanent magnet 501 to be able to withstand the centrifugal force generated by rotation; a shaft 504 which is fixed to the center of the rotor core 502 on the internal diameter side; bearing mechanisms 505 and 506 which rotate the shaft 504; and a structural member 507 which is connected to a gear and a load provided on the motor output side. Note that the present embodiment uses the 10-pole, 12-slot motor in which ten permanent magnets 501 are provided.

The structure of the stator core 200 and the bobbin 300 will now be described with reference to FIG. 5C. Each core includes a toric stator core back portion 201 and a stator tooth portion 202 which is projected toward the internal diameter from the core back portion 201. This split core arranged in the circumferential direction constitutes the stator core 200 illustrated in FIG. 5A. As illustrated in FIG. 5C, the bobbin 300 for insulating the stator core 200 from the stator coil 400 is split into bobbins 301 and 302 toward both sides of the axial direction, while the bobbins 301 and 302 are assembled such that the stator tooth portion 202 is interposed between the bobbins from the axial direction.

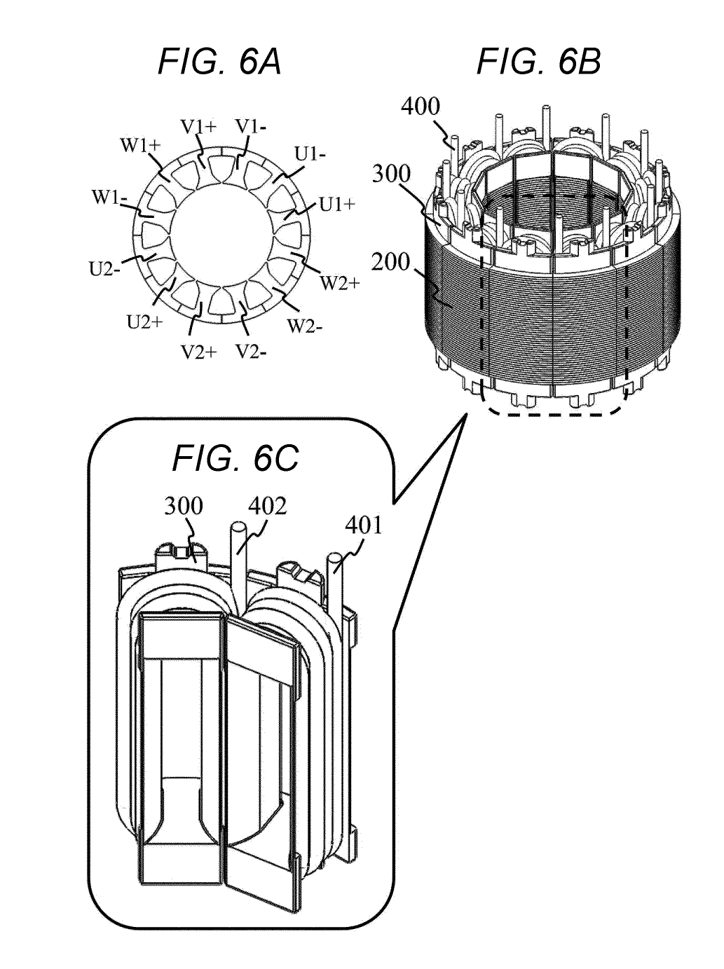

FIGS. 6A to 6C are diagrams provided to describe the present embodiment. FIG. 6A is a diagram illustrating a cross-sectional structure of the stator for the 10-pole, 12-slot or the 14-pole, 12-slot concentrated winding motor. As illustrated in FIG. 6A, the stator coil 400 is wound around each of 12 independent teeth in the concentrated winding pattern counter-clockwise in the order of U1+, U1−, V1−, V1+, W1+, W1−, U2−, U2+, V2+, V2−, W2−, and W2+. Note that the rotor with 10 poles and 14 poles employed in the same winding arrangement rotates in mutually different directions. The stator coils U1+ and U1− are wound such that the current flows through these coils in the mutually opposite directions. Likewise, the stator coils U2+ and U2− are wound such that the current flows through these coils in the mutually opposite directions. The stator coils U1+ and U2+ are wound such that the current flows through these coils in the same direction. Likewise, the stator coils U1− and U2− are wound such that the current flows through these coils in the same direction. The directional relationship of the current flowing through the stator coils V1+, V1−, V2+, and V2− and through the stator coils W1+, N1−, W2+, and W2− is similar to that of the U-phase coil.

Each of the 12 split cores constituting the stator core 200 and the stator coil 400 wound around the split core are manufactured in the similar manner. When two parallel circuits are provided for the U-phase coil including four teeth, for example, two of the stator coils continuously wound around the teeth in series and another two of the stator coils continuously wound around the teeth in series are connected through the bus bar or the like. When one parallel circuit is provided, on the other hand, all the stator coils is wound around the four teeth in a continuous manner. FIG. 6B is a diagram in which the 12 split cores constituting the stator core 200, the bobbin 300, and the stator coil 400 are assembled together. Incidentally, the stator core 200 is formed by laminating a thin plate formed of a magnetic material such as a magnetic steel sheet in the axial direction. This structure is effective at reducing an eddy current loss generated in the stator. FIG. 6C is a diagram in which adjacent coils in the same phase are wound in a continuous manner. The stator coil is wound from a winding start end 401 making n turns, and then moves to the adjacent tooth around which the stator coil is continuously wound with the number of turns that is greater or less than n turns by a whole number such that the coil is wound in the mutually opposite directions between the adjacent teeth. As a result, the slot space can be used effectively to improve the space factor as well as the flexibility in design. When the coil makes n turns around one tooth and n+1 turns around another tooth, for example, the number of turns adds up to 2 n+1 turns, which is an odd number that allows for the higher flexibility in design. The flexibility in design has not been increased in the related art where the coil makes n turns or n+1 turns around both of the adjacent teeth so that the number of turns of the coil continuously wound around the two teeth adds up to an even number of either 2 n or 2 n+2 turns but not the number in between. The use of the stator coil with a large wire diameter is particularly effective in terms of improving the space factor where the cross sectional area of the slot is large enough for the coil to make additional turns by not two turns but one turn near the center of the slot. In this case, the space within the slot is often used nearly up to its limit. Therefore, the slot space is required to be somewhat uniform in the circumferential direction such that the coil makes n turns around one tooth, the coil in the same phase makes n+1 turns around the adjacent tooth, and the coil in a different phase makes n turns around the next tooth in position. The same can be said of the case where the winding start end 401 and a winding finish end 402 are switched. Moreover, it is desired that the bobbin 300 include an arc-shaped guide to make it easier for the coil to be wound. It is also convenient in terms of manufacturing to devise means such that the winding start and finish ends can be identified by color. When the Y connection is employed, for example, the winding start and finish ends that are identified by color or the like make it easier for one to distinguish a neutral point connection side from an input line side.

### Second Embodiment

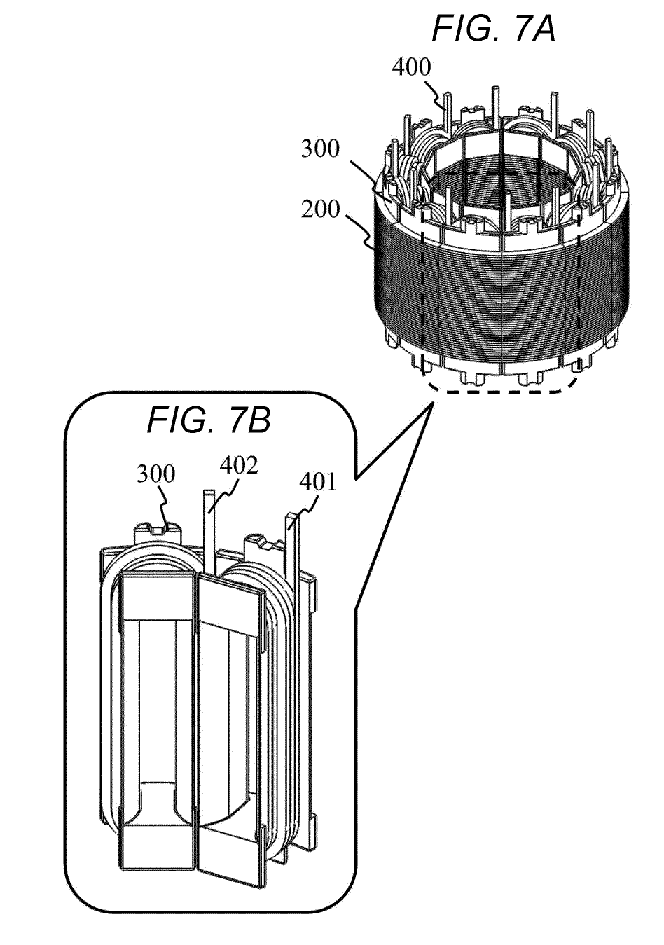

A second embodiment of the present invention will now be described with reference to FIGS. 7A and 7B. FIG. 7A is a diagram in which a stator core 200, a bobbin 300, and a stator coil 400 are assembled together. The stator coil 400 here is formed of a square wire or a rectangular wire. The square wire or the rectangular wire is suitable for a regular winding of the stator coil, by which one can expect a space factor to be increased. Compared with a round wire, moreover, the coil formed of the square or the rectangular wire is not displaced easily within a slot after being wound, which is comparatively convenient in terms of manufacturing. FIG. 7B is a diagram in which adjacent coils in the same phase are wound in a continuous manner. The stator coil is continuously wound around two teeth from a winding start end 401 to a winding finish end 402. As with the first embodiment, the coil makes n turns around one of the teeth, and the coil in the same phase makes the number of turns that is greater or less than n turns by a whole number around the adjacent tooth. Moreover, it is desired that the bobbin 300 include a square-shaped guide to make it easier for the coil to be wound. Furthermore, as with the first embodiment, it is convenient in terms of manufacturing to devise means such that the winding start and finish ends can be identified by color. When a Y connection is employed, for example, the winding start and finish ends that are identified by color or the like make it easier for one to distinguish a neutral point connection side from an input line side.

### Third Embodiment

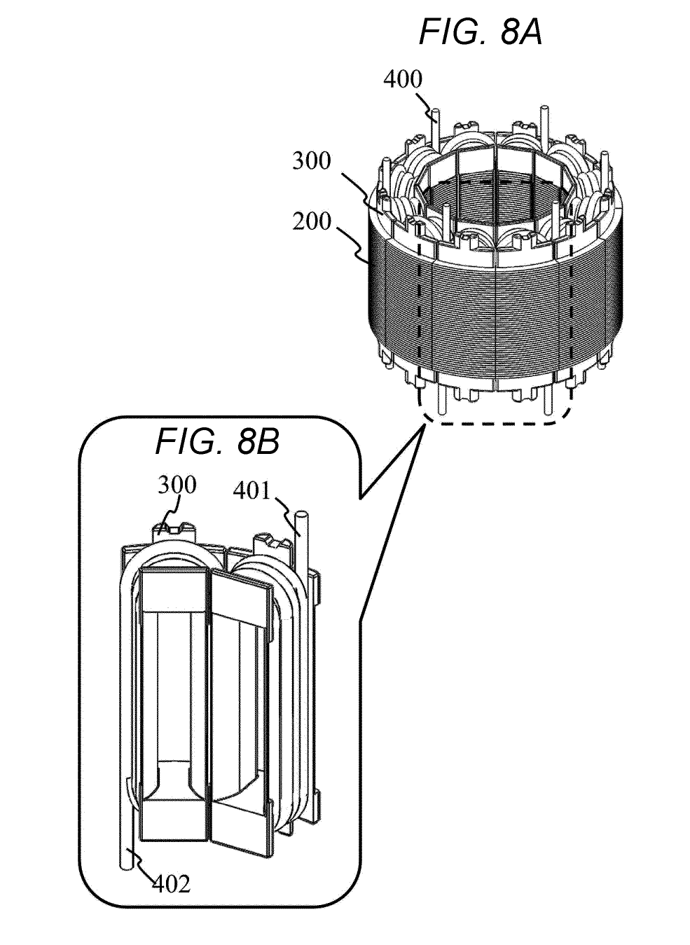

A third embodiment of the present invention will now be described with reference to FIGS. 8A and 8B. FIG. 8A is a diagram in which a stator core 200, a bobbin 300, and a stator coil 400 are assembled together. FIG. 8B is a diagram in which adjacent coils in the same phase are wound in a continuous manner. The stator coil is wound from a winding start end 401 making n turns, and then moves to the adjacent tooth around which the stator coil makes m turns in a continuous manner in a direction opposite to the adjacent tooth, the m turns corresponding to the number of turns that is greater or less than n turns by 0.5 turns. Note that each of the n and the m takes an integer value. As a result, a slot space can be used effectively to improve a space factor as well as the flexibility in design. As with the first and the second embodiments, the number of turns can be selected by a small increment so that the flexibility in design can be drastically increased. In this case, moreover, the winding start and finish ends are led out in the axially opposite directions so that a neutral point connection side can be separated from an input line side when a Y connection is employed, and that it is convenient in terms of manufacturing since a space can be secured for a mechanism such as a relay which is to be provided to the neutral point side, for example. The space within the slot with this type of design is often used nearly up to its limit as is the case with the first and the second embodiments. Therefore, the slot space is required to be somewhat uniform in the circumferential direction such that the coil makes n turns around one tooth, the coil in the same phase makes 0.5 turns more than the n turns around the adjacent tooth, and the coil in a different phase makes n turns around the next tooth in position. The same can be said of the case where the winding start end 401 and a winding finish end 402 are switched. Moreover, it is desired that the bobbin 300 include an arc-shaped guide to make it easier for the coil to be wound.

### Fourth Embodiment

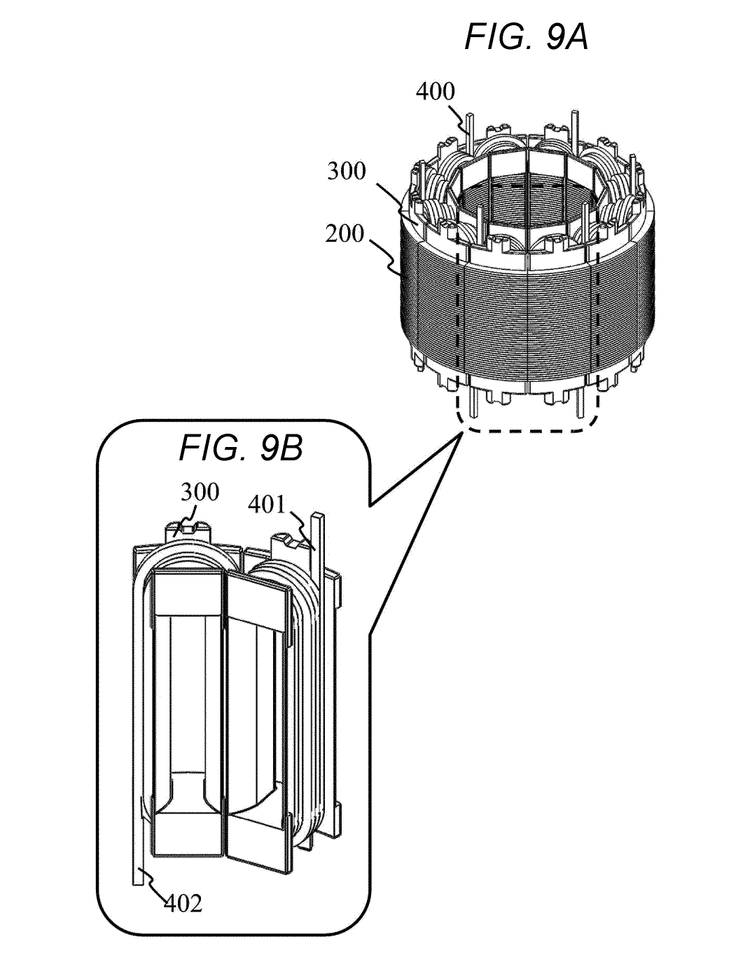

A fourth embodiment of the present invention will now be described with reference to FIGS. 9A and 9B. FIG. 9A is a diagram in which a stator core 200, a bobbin 300, and a stator coil 400 are assembled together. The stator coil 400 here is formed of a square wire or a rectangular wire. The square wire or the rectangular wire is suitable for a regular winding of the stator coil, by which one can expect a space factor to be increased. Compared with a round wire, moreover, the coil formed of the square or the rectangular wire is not easily displaced within a slot after being wound, which is comparatively convenient in terms of manufacturing. FIG. 9B is a diagram in which adjacent coils in the same phase are wound in a continuous manner. The stator coil is continuously wound around two teeth from a winding start end 401 to a winding finish end 402, as with the third embodiment. As with the third embodiment, moreover, the coil makes n turns around one of the teeth, and the coil in the same phase makes the number of turns that is greater or less than n turns by 0.5 turns around the adjacent tooth. Note that each of the n and m takes an integer value. Moreover, it is desired that the bobbin 300 include a square-shaped guide to make it easier for the coil to be wound. Furthermore, as with the third embodiment, the winding start and finish ends can be separated in the axial direction so that a neutral point connection side can be separated from an input line side. This is convenient in terms of manufacturing since a space can be secured for a mechanism such as a relay which is to be provided to the neutral point side, for example.

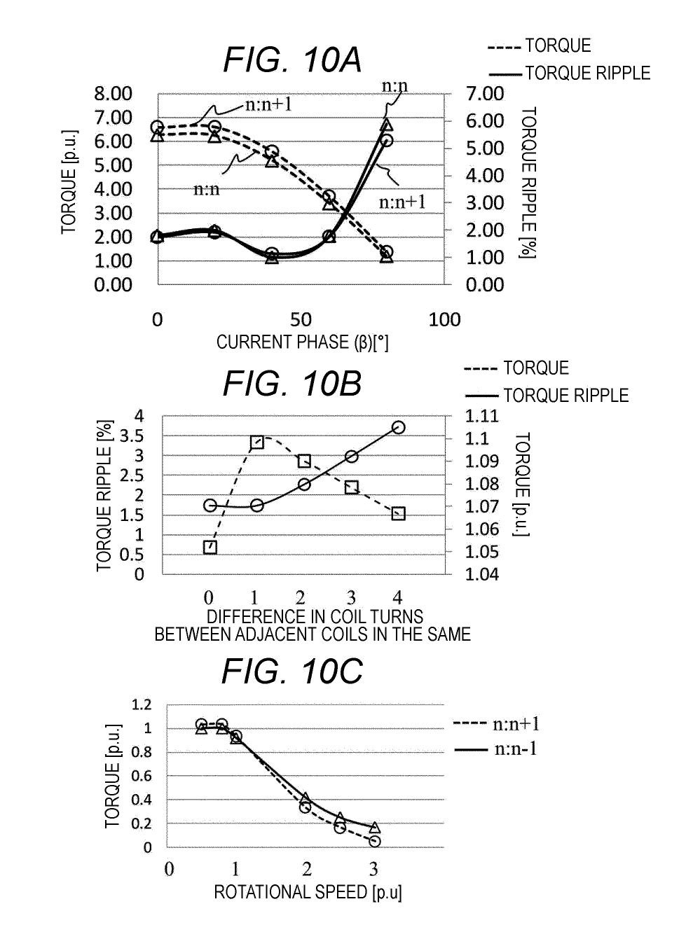

In the aforementioned embodiments where the number of coil turns around the square tooth varies, a magnetic unbalance can possibly be induced when the motor is energized. Practically, this unbalance is not much of an effect because the torque of the motor is determined by a resultant vector of adjacent coils in the same phase when the motor has the combination of the number of poles and the number of slots of either 10:12 or 14:12. FIGS. 10A to 10C are a set of graphs illustrating a characteristic example. It can be understood from the graph that the torque ripple hardly varies between a case where adjacent coils in the same phase make n turns each (n:n) and a case where the coils make n turns and n+1 turns (n:n+1), respectively. However, the magnetic unbalance is expected to increase when the difference in the number of turns between the adjacent coils in the same phase becomes too large. FIG. 10B is a graph illustrating the change in a torque value and a torque ripple value in relation to the difference in the number of coil turns between the adjacent coils in the same phase. Due to the stringent constraint imposed on the torque ripple in the EPS motor, it is desired that the torque ripple be kept at 2.5% or less. Accordingly, it is desired that the difference in the number of coil turns between the adjacent coils in the same phase be around two turns. FIG. 10C is a graph illustrating the torque performance with respect to the rotational speed of the motor when the adjacent coils in the same phase make n turns each (n:n) and when the coils make n turns and n+1 turns (n:n+1), respectively. When the adjacent coils in the same phase make n turns and n+1 turns, respectively (n:n+1), the large torque output from the motor running at a low rotation speed is not output easily as the motor runs at a higher rotational speed because the counter-electromotive force is increased. When the adjacent coils in the same phase make n turns and n−1 turns, respectively (n:n−1), the motor running at up to a high rotational speed region can still output torque with the same control method used because the counter-electromotive force is small when the motor runs at a high rotational speed, though the torque is decreased at a low rotational speed. In order to ensure the characteristic in the required region, it is thus desired that the number of turns be adjusted in the EPS motor or the like requiring high rotational speed-torque characteristic.

Hereinafter, the structure of the stator and the rotor of the motor according to the present embodiment will be described in detail.

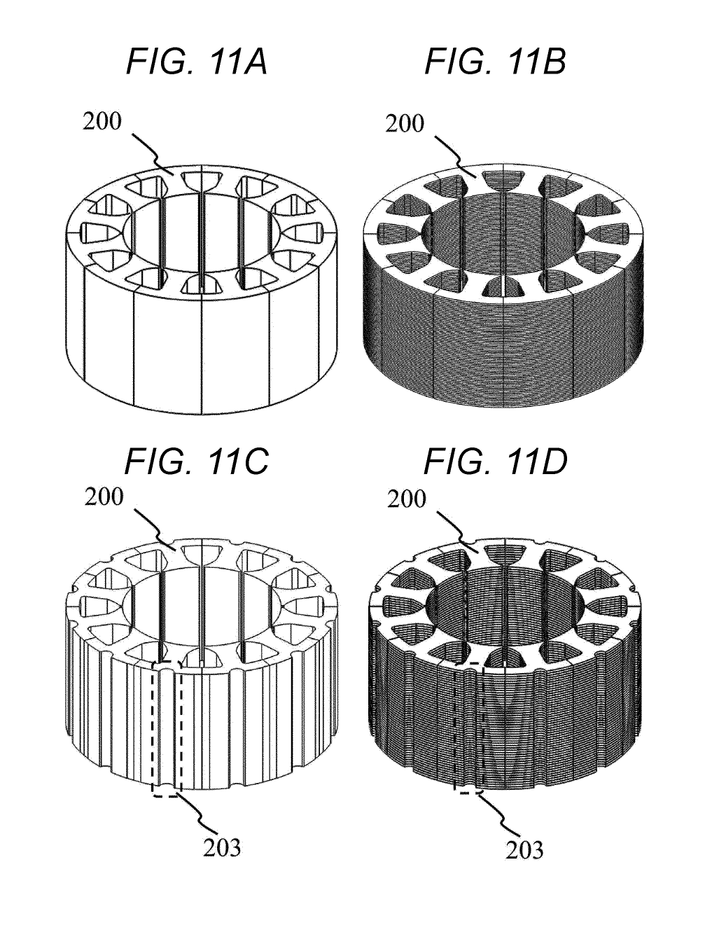

FIGS. 11A to 11D are diagrams illustrating the structure of the stator. The stator core requires various means to be implemented in order to suppress the loss generated in the core as much as possible. Take for example the stator core including 12 split cores as illustrated in FIG. 11A. There is a large eddy current loss when each split core is formed of pure iron, while the eddy current generated in the core can be suppressed when the split core is formed of a pressed powder core. The eddy current can also be suppressed by employing a laminate of steel sheets in which a thin sheet-like soft magnetic material is laminated in the axial direction as illustrated in FIG. 11B. In this case, the thinner the sheet, the more effectively the eddy current can be suppressed. Moreover, a groove 203 provided in the axial direction of the split core for the both stators illustrated in FIGS. 11A and 11B allows a fixing jig such as a through-bolt to pass through the groove. FIG. 11C is a diagram illustrating the stator core formed of the pressed powder core, whereas FIG. 11D is a diagram illustrating the stator core formed of the steel sheet laminate. It is desired that a groove be provided on the radially outer side of the tooth by taking the path of the magnetic flux into consideration. Moreover, it is better to round the corner of the radially outer side of the slot in order to alleviate the magnetic saturation. Furthermore, the tooth of the stator core is smoothly spread out in the shape of a brass instrument toward the internal diameter side in order to alleviate the magnetic saturation when loaded.

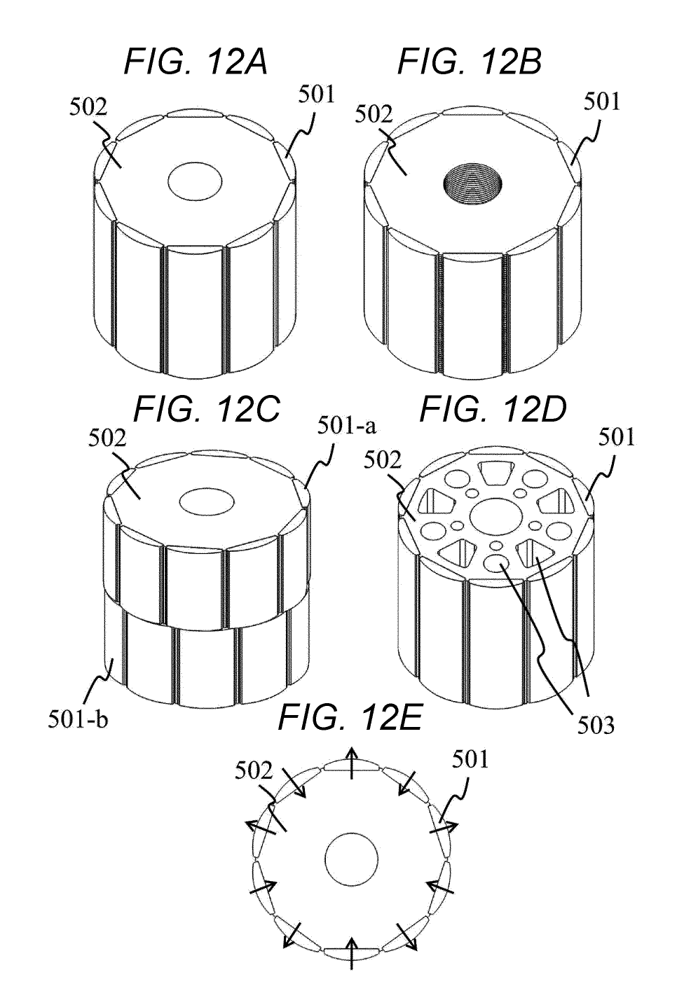

FIG. 12A is a diagram illustrating the structure of the rotor. The rotor core 502 is formed of a magnetic material, where the permanent magnet 501 segment is stuck to the surface of the pure iron. A locking mechanism is provided between the plurality of permanent magnets, between which the rotor core is projected. This projection is preferably about half as tall as the edge of the magnet so as to avoid an adverse effect caused when the projection is too tall in the radial direction. When there is a large eddy current loss in the rotor core 502, the rotor core 502 may be formed of the pressed powder core or formed by laminating a thin electromagnetic steel sheet as illustrated in FIG. 12B. Moreover, the cross section of each permanent magnet 501 has a semicylindrical or “kamaboko” shape. The kamaboko shape has the radial thickness that is smaller on both sides than at the center in the circumferential direction. This kamaboko shape allows the magnetic flux to have a sinusoidal distribution, whereby the induced voltage generated by the rotation of the EPS motor has a sinusoidal waveform so that the ripple can be reduced. The steering feeling perceived by the driver can thus be improved by the reduction of the ripple. Note that when the magnet is formed by magnetizing the ring-shaped magnetic material, the magnetizing force may be controlled such that the magnetic flux has the sinusoidal distribution. Moreover, as illustrated in FIG. 12C, the rotor can be divided into a plurality of pieces and stacked in the axial direction so that, by shifting at least one of the rotor pieces by a predetermined angle in the circumferential direction, the ripple in the rotor magnetomotive force can be cancelled in the axial direction to reduce the cogging torque and the torque ripple. Furthermore, a hole provided in the rotor core as illustrated in FIG. 12D can be used for positioning the rotor or suppressing the moment of inertia. In this case, it is desired that the hole be positioned at some distance away from the magnet in order to not interfere with the path of the magnetic flux. Alternatively, the permanent magnet 501 may be magnetized in the direction that alternates between the adjacent magnets as illustrated in FIG. 12E.

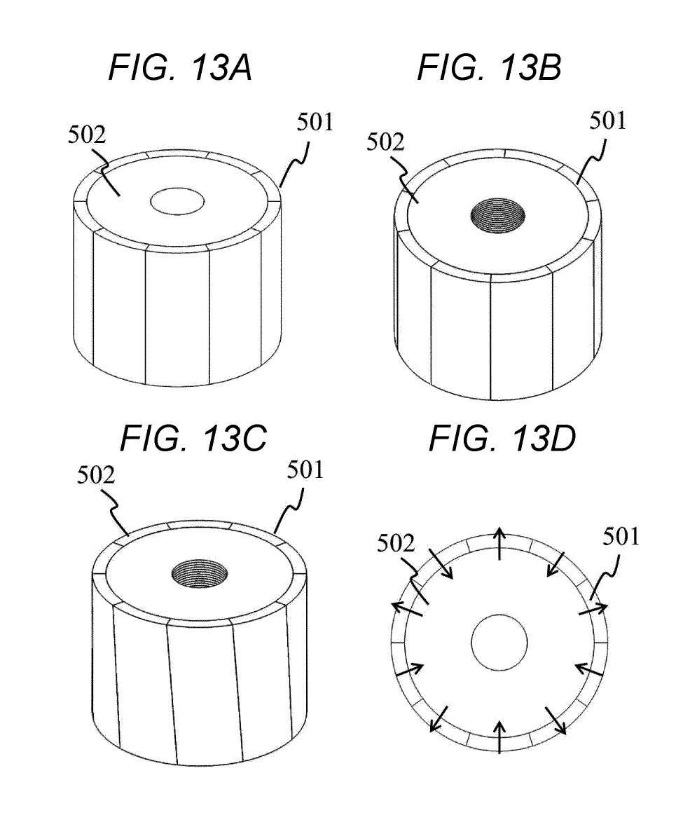

FIGS. 13A to 13D are diagrams likewise illustrating the structure of the rotor. As illustrated in FIG. 13A, the rotor core 502 is formed of a magnetic material, where the ring-shaped permanent magnet 501 is stuck to the surface of the pure iron. When there is a large eddy current loss in the rotor core, the rotor core may be formed of a pressed powder core or formed by laminating a thin electromagnetic steel sheet as illustrated in FIG. 13B. When a ring magnet is employed, the magnet can also be skewed continuously. That is, as illustrated in FIG. 13C, the magnet can be skewed in the axial direction at a predetermined angle so that the cogging torque and the torque ripple can be reduced. The permanent magnet is magnetized in the direction such that each pole is magnetized in parallel with the direction of an arrow illustrated in FIG. 13D, or magnetized radially along the circle of the rotor magnet.

What is claimed is:

1. A permanent magnet rotating electrical machine driven by polyphase AC power, the rotating electrical machine comprising:
a stator including:
a stator core; and
a polyphase stator coil incorporated into the stator core; and
a rotor which is rotatably disposed in opposed relation to the stator through an air gap, the rotor including:
a rotor core; and
a plurality of permanent magnets which is fixed to an outer peripheral surface of the rotor core,
wherein a slot is formed between adjacent tooth core portions in the stator core,
the stator coil is housed in the slot,
a ratio of the number of slots to the number of poles of the permanent magnet is 12:10 or 12:14, and
adjacent stator coils in the same phase among the stator coil have the number of coil turns that are different from each other.

2. The rotating electrical machine according to claim 1, wherein a difference in the number of coil turns between the adjacent coils in the same phase among the stator coil is within two turns.

3. The rotating electrical machine according to claim 2, wherein the stator core is formed by joining a plurality of split core pieces, each of which being arranged and fixed in a circumferential direction integrally includes:
an annular back core portion; and
at least one tooth core portion projected in a radial direction, the annular back core portion having a width corresponding to an angle obtained by dividing 360 degrees by the number of slots.

4. The rotating electrical machine according to claim 1, wherein the rotating electrical machine is used for an electric power steering.

5. The rotating electrical machine according to claim 2, wherein the adjacent coils in the same phase among the stator coil are wound in a continuous manner, a winding start end and a winding finish end of the adjacent coils being led out at an axial end in mutually opposite directions.

6. The rotating electrical machine according to claim 2, comprising an insulating bobbin between the stator coil and the stator tooth portion around which the stator coil is wound, the bobbin being incorporated so as to sandwich the stator core from two axial directions.
